(19) United States
(12) Patent Application Publication
(10) Pub. No.: US 2007/0090957 A1
(43) Pub. Date: Apr. 26, 2007

(54) RFID antenna rack assembly

(75) Inventor: Albert D. Kozlovski, Atkinson, NH (US)

Correspondence Address: TYCO TECHNOLOGY RESOURCES, 4550 NEW LINDEN HILL ROAD, SUITE 140, WILMINGTON, DE, 19808-2952, US

(73) Assignee: M/A-COM, Inc., Lowell, MA (US)

(21) Appl. No.: 11/506,354

(22) Filed: Aug. 18, 2006

Related U.S. Application Data
(60) Provisional application No. 60/729,918, filed on Oct. 25, 2005.

(51) Int. Cl. G08B 13/14; H01Q 1/12

(52) U.S. Cl. 340/572.7; 343/878

(57) ABSTRACT

An antenna rack assembly comprising a base, a top spaced apart from the base, at least two beam members, each fixedly attached at one end to the base and at another end to the top, for mounting at least one antenna component, and one or more covers removably attached to the beam members for covering components mounted to said beam members, the one or more covers having a curved contour and being made of a material suitable for radio frequency (RF) transmissions.

### CROSS REFERENCE TO RELATED APPLICATIONS

This application claims the benefit of U.S. Provisional Application No. 60/729,918, filed Oct. 25, 2005, entitled “RFID ANTENNA RACK ASSEMBLY.”

### FIELD OF INVENTION

The present invention relates generally to antenna racks. More particularly, the present invention relates to an antenna rack assembly that includes protective covers for adding to the structural integrity of the rack assembly and for facilitating radio frequency transmissions from antenna components mounted in the rack assembly.

### BACKGROUND OF THE INVENTION

Antenna mounting racks are widely utilized for mounting multiple antenna components including, for example, Radio Frequency Identification (RFID) antennas. Existing antenna rack designs, such as is illustrated in FIG. 1, typically include metal support frames 102a, 102b; one or more cross members 104 for joining the support frames 102a, 102b and/or for supporting antenna components mounted therein; and one or more rack covers 108a, 108b which are mounted to the support frames 102a, 102b via apertures 109 along a lateral surface of the support frames 102a, 102b. The conventional rack assembly 100 of FIG. 1 is shown with one of its covers removed (not shown) to expose an antenna component 106 mounted therein.

As is illustrated in FIG. 1, the covers 108a, 108b of the rack assembly 100 are flat and are typically made of metal. Those skilled in the art will appreciate that these flat covers 108a, 108b do nothing to add to the structural integrity of the rack assembly 100. In fact, the sole purpose of these covers 108a, 108b is to protect any antenna component(s) 106 mounted in the rack assembly 100 from common hazards typically present in environments utilizing such rack assemblies 100.

Highlighted in FIG. 1 is a mounted antenna component 106. This antenna component 106, along with any other such component mounted to the rack assembly 100, includes its own radome cover 106a. The radome cover 106a serves to enable the transmission of RF signals. As further discussed below, the present invention eliminates the need for such component-specific radome covers.

In view of the existing state of the art, it is desirable to have an antenna rack assembly with rack covers that are easily removable, yet provide additional strength and support for the rack assembly. It is also desirable to have an antenna rack assembly with covers that also function as dielectric radome covers, thus eliminating the need for each individual antenna component to include its own radome cover.

### SUMMARY OF THE INVENTION

The present invention relates to an antenna rack assembly comprising a base, a top spaced apart from the base, at least two beam members, each fixedly attached at one end to the base and at another end to the top, for mounting at least one antenna component, and one or more covers removably attached to the beam members for covering components mounted to said beam members, the one or more covers being generally curved in contour and being made of a material suitable for radio frequency (RF) transmissions.

In another aspect of the present invention, an antenna rack assembly comprises a base defining a plurality of mounting apertures for mounting a rack assembly to a mounting location; a top spaced apart from the base; a pair of parallel, U-shaped beam members fixedly attached at one end to the base and at another end to the top; at least one cross-member positioned between the beam-members and removably attached thereto, the at least one cross-member being suitable for supporting at least one antenna component; at least one antenna component mounted to the at least one cross-member; and a plurality of covers removably attached to the rack assembly for covering the at least one antenna component. The covers are generally curved in contour and are made of a material suitable for RF transmissions.

In yet another aspect, the present invention relates to a radio frequency identification (RFID) antenna rack comprising a base defining a plurality of mounting apertures for mounting a rack assembly to a mounting location; a top spaced apart from the base; and a pair of parallel beam members each fixedly attached at one end to the base and at another end to the top. The beam members define anterior and posterior mounting surfaces suitable for mounting antenna components. In addition, the RFID antenna rack assembly comprises at least one cross-member positioned between the beam-members and removably attached thereto, the at least one cross-member being suitable for supporting at least one antenna component; a plurality of RFID antenna components, each mounted to one of the anterior mounting surface, the posterior mounting surface, and the at least one cross-member; and a plurality of covers removably attached to the beam members for covering the plurality of RFID antenna components. The covers are generally curved in contour and are made of a material suitable for RF transmissions.

### BRIEF DESCRIPTION OF THE DRAWINGS

The present invention is described with reference to the following Figures, wherein:

FIG. 1 illustrates a conventional antenna rack assembly utilizing conventional rack covers;

FIG. 2A illustrates a framework of an exemplary rack assembly in accordance with the present invention;

FIG. 2B illustrates the exemplary antenna rack assembly of FIG. 2A, with additional components in accordance with the present invention;

FIG. 3 illustrates an exemplary implementation of an antenna rack assembly in accordance with the present invention; and

### DETAILED DESCRIPTION OF THE PREFERRED EMBODIMENTS

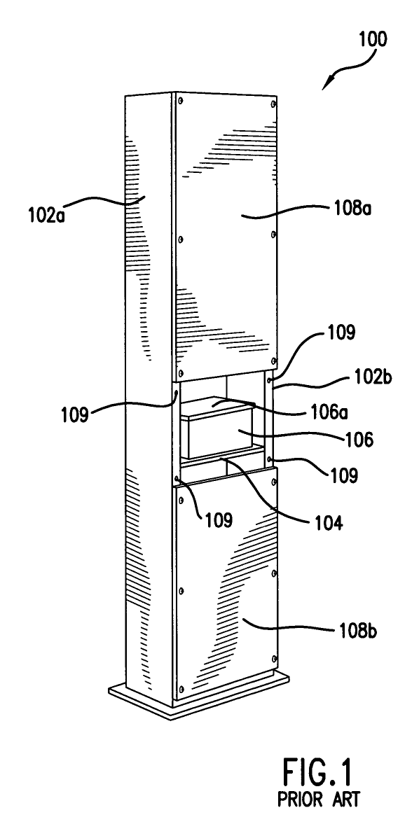

Described herein is a novel antenna rack assembly for use in mounting multiple antennas and/or associated antenna components such as readers, GPIO boxes, power supplies, Ethernet connections, junction boxes, and the like. Unlike conventional rack assemblies (see FIG. 1), the antenna rack of the present invention includes structurally enhancing rack covers that not only serve to strengthen the rack assembly, but also serve as radome covers for antenna components mounted to the rack assembly. In addition, the present invention provides added flexibility with regard to the quantity, size, and types of components that are mounted therein, and added accessibility to these internally-mounted components.

In one preferred embodiment, the antenna rack assembly of the present invention comprises a base portion, a top portion, a pair of parallel beam members, and a plurality of curved rack covers. The base portion optionally defines mounting apertures for mounting the rack assembly to a desired mounting location. The beam members are each fixedly attached at one end to the base portion and at the other end to the top portion, thereby forming the framework of a preferred rack assembly. The beam members preferably define at least one substantially flat mounting surface suitable for mounting antenna component(s) thereto. In a preferred embodiment, the beam members define at least two mounting surfaces, an anterior mounting surface and a posterior mounting surface.

Once a desired number of antennas and/or associated components are mounted to the rack assembly, the curved rack covers are attached directly to the rack assembly framework. These covers are removably attached to the rack assembly and their curved contour serve to strengthen the structural integrity of the rack assembly. In addition, since these rack covers are made of a material suitable for RF transmissions, they serve as radome covers for antenna components mounted in the rack assembly, thereby eliminating the need for the antenna components to include their own respective radome cover.

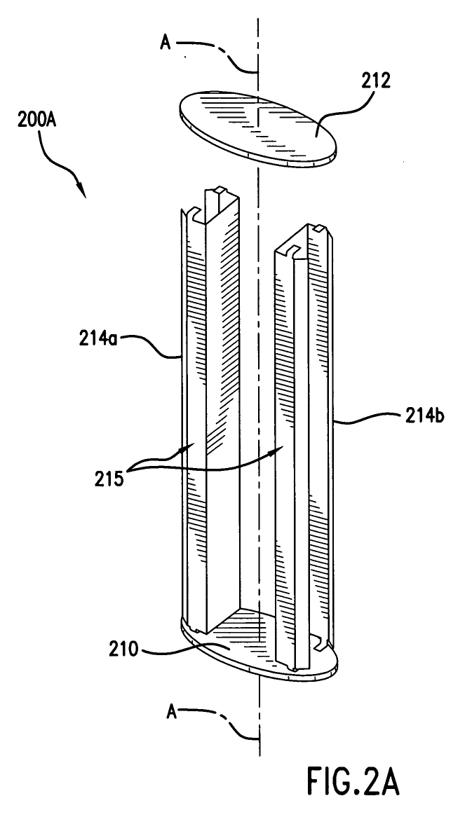

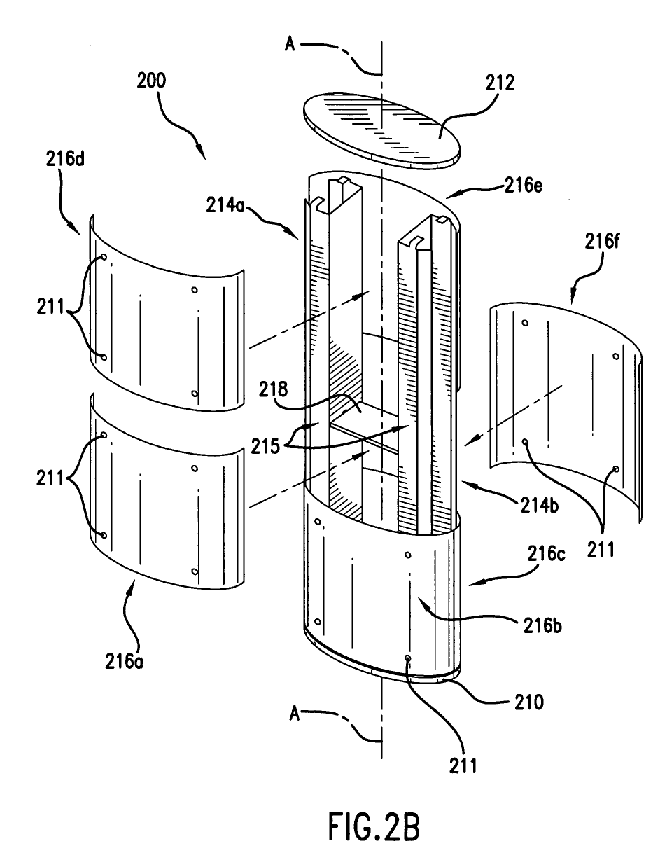

Referring now to FIGS. 2A and 2B, exploded views of an exemplary framework 200A and completed rack assembly 200, respectively, in accordance with the present invention are shown. The framework 200A comprises a base 210, a top 212, a pair of parallel beam members 214a, 214b, while the completed rack assembly 200 comprises the framework 200A and a plurality of rack covers 216a-216f. Also included in the exemplary rack assembly 200 is an optional cross member 218.

The base 210 of the rack assembly 200 functions as a ‘foundation’ of the assembly 200 in that it supports and optionally provides a mounting means for the completed assembly 200. To this end, the base 210 is preferably made of a strong, rigid material, such as metal or the like, although any suitable material may utilized in forming the base 210. Included in the base 210 are a plurality of optional mounting apertures (not shown), for use in mounting the rack assembly 200 to any desired mounting location. Alternatively or additionally, rack assembly 200 may be mounted via optional apertures defined in the beam members (not shown), or via optional mounting bracket(s) (not shown) attached to any portion of the rack assembly 200. For mounting locations requiring an expanded mounting surface, or for irregularly shaped mounting surfaces, the completed rack assembly 200 may first be attached to an optional mounting base (not shown), and in turn, mounted to the desired mounting location.

Spaced apart from the base 210 along a longitudinal access A is a top 212. The top 212 is preferably utilized to house electrical connectors (not shown), for use in connecting antennas and/or associated components within the completed rack assembly 200. In a preferred embodiment, the top 212 is made of a metal or similar type material. It is noted, however, that since the top 212 is not a point of support for the rack assembly 200, it need not be formed from the same heavy-duty material used in forming the base 210.

Situated between the base 210 and the top 212 are the pair of parallel beam members 214a, 214b. Although these beam members 214a, 214b are shown to be substantially U-shaped, it should be understood that any appropriate or desired shape may be utilized in configuring the beam members 214a, 214b. For example, the beam members may be triangular, rectangular, etc. The beam members 214a, 214b are also shown having optional tab portions protruding therefrom. These tab portions contribute structurally to the rack assembly 200 and may be formed to protrude at any appropriate angle suitable for the particular application.

Referring back to FIGS. 2A and 2B, the beam members 214a, 214b are attached at one end to the base 210, and at the other end to the top 212 via, for example, metal fasteners. In a preferred embodiment, these beam members 214a, 214b are made of a strong material, such as metal, suitable for supporting multiple antennas and/or associated components. As shown in FIG. 2A, once assembled, the base 210, the beam members 214a, 214b, and the top 212 collectively form the underlying framework 200A and define an overall footprint of the rack assembly 200 of the present invention.

The beam members 214a, 214b combine to define an optional mounting surface 215, suitable for mounting antenna components and/or for attaching the rack covers 216a, 216b, and 216d thereto via optional attachment apertures 211 defined in the covers 216a, 216b, and 216d. In a preferred embodiment, the beam members 214a, 214b combine to define at least two mounting surfaces, an anterior mounting surface 215 and a posterior mounting surface (not shown) on the opposite side of the rack assembly 200. In this way, antenna components and covers may be mounted to either or both sides of the rack assembly 200.

Located between the parallel beam members 214a, 214b in FIG. 2B, is an optional cross-member 218. This cross member 218 may comprise any appropriate material and be configured in any appropriate shape suitable for holding one or more antennas and/or related components.

Completing the rack assembly 200 of the present embodiment are a plurality of covers 216a-216f. These covers 216a-216f are generally curved and/or elliptical in contour. The curvature of the covers 216a-216f may be defined, for example, as a continuous curve, as illustrated in FIG. 2B, or as a multi-faceted geometric shape that achieves the desired curvature. Whether the curvature is continuous or non-continuous, those skilled in the art will appreciate that contouring the rack covers 216a-216f in this manner provides added strength to the covers 216a-216f, and structural integrity to the rack assembly 200. To further strengthen the rack assembly 200, the covers 216a-216f may optionally be ribbed in a lateral direction, along an interior surface of the covers 216a-216f,

It will also be appreciated by those skilled in the art that the curvature of the covers 216a-216f enables antenna components to be mounted outside the beam members 214a, 214b, thus reducing or eliminating electrical issues associated with antenna components being mounted flush with, or below the beam members 214a, 214b. It should be noted, however, that although the covers 216a-216f of the present embodiment are shown having a pronounced curvature, covers having a smaller, or even greater curvature may be utilized in accordance with the present invention. Furthermore, although the covers 216a-216f of the present embodiment are shown to form a sleeve-like cover over the rack assembly 200, it should be understood that the covers 216a-216f need not be configured in this manner. In an alternate embodiment, for example, the rack assembly covers 216a-216f may be configured to cover just the anterior (215) and posterior (now shown) mounting surfaces defined by the beam members 214a, 214b. In such an embodiment, covers (e.g., 216a, 216b, 216d) attached to the anterior mounting surface 215 would not contact the covers (e.g., 216c, 216e, 216f) attached to the posterior mounting surface, thus exposing the lateral surfaces of the beam members 214a, 214b.

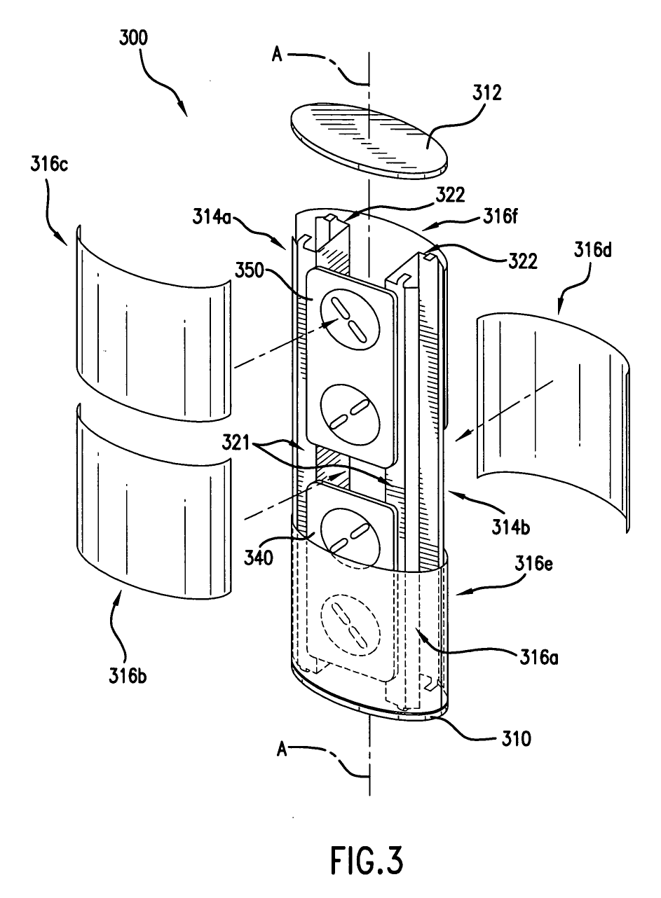

Referring now to FIG. 3, an exemplary RFID antenna rack assembly 300 in accordance with the present invention is shown. Similar to the rack assembly 200 illustrated in FIG. 2, the present rack assembly 300 comprises a base 310, a top 312, a pair of parallel, U-shaped beam members 314a, 314b, and a plurality of rack covers 316a-316f Also included in the present rack assembly 300 are multiple RFID antenna components 340, 350 mounted above the beam members 314a, 314b.

The base 310 of the rack assembly 300 is made of a metal material and has a substantially curved contour. The base 310 further defines a plurality of optional mounting apertures (not shown), for use in mounting the rack assembly 300 to any desired mounting location. Alternatively or additionally, rack assembly 300 may be mounted via optional apertures defined in the beam members (not shown), or via optional mounting bracket(s) (not shown) attached to any portion of the rack assembly 300. For mounting locations requiring an expanded mounting surface, or for irregularly shaped mounting surfaces, the completed rack assembly 300 may first be attached to an optional mounting base (not shown), and in turn is mounted to the desired mounting location.

Spaced apart from the base 310, along a longitudinal access A, is the top 312. The top 312 houses multiple electrical connectors 313 for use in connecting the RFID antenna components 340, 350. Like the base 310, the top 312 is made of a metal material and is substantially curved in contour. As further discussed below, the curved contour of the base 310 and top 312 facility the attachment of the curved covers 316a-316f. Together, the base 310 and top 312 define a footprint of the present antenna rack assembly 300.

Situated between the base 310 and the top 312 are the pair of metal, U-shaped, beam members 314a, 314b. These beam members 314a, 314b are attached at one end to the base 310, and at the other end to the top 312 via metal fasteners (not shown). As FIG. 3 illustrates, the beam members 314a, 314b are attached to the base 310 and top 312 so as not to protrude the footprint defined by said base 310 and top 312.

The beam members 314a, 314b combine to form an anterior mounting surface 321, and a posterior mounting surface 322 opposite the anterior mounting surface 321. These mounting surfaces 321, 322 are suitable for mounting RFID antenna and other related components, and for attaching the rack covers 316a-316f. In the present rack assembly 300, two RFID antenna components 340, 350 are mounted to the anterior mounting surface 321 via their respective ground plates. As can be appreciated by those skilled in the art, mounting the components' 340, 350 ground plates directly to an anterior surface 321 of the beam members 314a, 314b further adds to the structural strength of the rack assembly 300 and eliminates electrical issues associated with components mounted flush with, or below the beam members 314a, 314b. Although the posterior mounting surface 322 is not visible in FIG. 3, it should be understood that additional antenna components may be mounted thereto.

Completing the present antenna rack assembly 300 are the plurality of rack covers 316a-316f. These covers 316a-316f are generally curved, and somewhat elliptical in contour. They also include optional ribbing along an interior lateral surface of the covers 316a-316f. As previously discussed, the ribbing and the elliptical shape provide added strength to the covers 316a-316f and added structural strength to the rack assembly 300. In addition, since the rack covers 316a-316f are made of a material suitable for RF transmissions, e.g., a dielectric material, the rack covers 316a-316f may serve as radome covers for any components mounted in the rack assembly 300. As can be seen in FIG. 3, the RFID antenna components 340, 350 are mounted to the rack assembly 300 without their respective radome covers. Thus, the rack covers 316a-316f in the present embodiment also serve as radome covers for the RFID antenna components 340, 350.

It should be noted that although the present invention was described in terms of “preferred” embodiments, the above-described embodiments are merely examples, and serve to set forth a clear understanding of the present invention. There are many modifications, permutations, and equivalents which may be made to these embodiments without departing from the spirit of the present invention. It is therefore intended that the following claim set be interpreted to include all such modifications, permutations, and equivalents that fall within the scope and spirit of the present invention.

What is claimed is:

1. An antenna rack assembly comprising:
a base;
a top spaced apart from the base;
at least two beam members, each fixedly attached at one end to the base and at another end to the top, for mounting at least one antenna component; and
one or more covers removably attached to the beam members for covering components mounted to said beam members, the one or more covers being generally curved in contour and being made of a material suitable for radio frequency (RF) transmissions.

2. The rack assembly of claim 1, wherein the one or more covers are generally elliptical in contour.

3. The rack assembly of claim 1, wherein the one or more covers are made of a dielectric material.

4. The rack assembly of claim 1, wherein the one or more covers are ribbed across a lateral interior surface of each said cover for providing added strength to the covers and added structural integrity to the rack assembly.

5. The rack assembly of claim 1, wherein the beam members are substantially U-shaped.

6. The rack assembly of claim 5, wherein the beam members define at least one substantially flat mounting surface suitable for mounting antenna components thereto.

7. The rack assembly of claim 6, wherein the top further comprises at least one electrical connection for connecting at least one antenna components thereto.

8. The rack assembly of claim 7, wherein the base, top, and beam members are made of metal and wherein said beam members are attached to the base and to the top via metal fasteners.

9. The rack assembly of claim 8, wherein the one or more covers are in the form of a sleeve, thereby fully covering the beam members and any component mounted thereto.

10. The rack assembly of claim 9, further comprising at least one cross-member positioned between the beam-members and removably attached thereto, the at least one cross-member being suitable for supporting at least one antenna component.

11. The rack assembly of claim 10, further comprising a first and a second antenna component, the first antenna component being mounted to the at least one mounting surface defined by the beam members, and the second antenna component being mounted to the at least one cross-member, wherein the one or more covers serve as radome covers for said first and second antenna components.

12. An antenna rack assembly comprising:
a base defining a plurality of mounting apertures for mounting a rack assembly to a mounting location;
a top spaced apart from the base;
a pair of parallel, U-shaped beam members each fixedly attached at one end to the base and at another end to the top;
at least one cross-member positioned between the beam-members and removably attached thereto, the at least one cross-member being suitable for supporting at least one antenna component;
at least one antenna component mounted to the at least one cross-member; and
a plurality of covers removably attached to the rack assembly for covering the at least one antenna component, said covers being generally curved in contour and being made of a material suitable for RF transmissions.

13. The rack assembly of claim 12, wherein the plurality of covers are generally elliptical in contour.

14. The rack assembly of claim 12, wherein the plurality of covers are made of a dielectric material.

15. The rack assembly of claim 12, wherein the covers are ribbed across a lateral interior surface of each said cover for providing added strength to the covers and added structural integrity to the rack assembly.

16. The rack assembly of claim 15, wherein the beam members define anterior and posterior mounting surfaces suitable for mounting antenna components to the beam members.

17. The rack assembly of claim 16, further comprising:
at least a second antenna component mounted to the anterior mounting surface and at least a third antenna component mounted to the posterior mounting surface.

18. The rack assembly of claim 17, wherein the beam members are made of metal and wherein said beam members are attached to the base and to the top via metal fasteners.

19. The rack assembly of claim 18, further comprising a mounting base removably attached to the base, for mounting the rack assembly to a mounting location.

20. A radio frequency identification (RFID) antenna rack comprising:
a base defining a plurality of mounting apertures for mounting a rack assembly to a mounting location;
a top spaced apart from the base;
a pair of parallel beam members each fixedly attached at one end to the base and at another end to the top, said beam members defining anterior and posterior mounting surfaces suitable for mounting antenna components;
at least one cross-member positioned between the beam-members and removably attached thereto, the at least one cross-member being suitable for supporting at least one antenna component;
a plurality of RFID antenna components, each mounted to one of the anterior mounting surface, the posterior mounting surface, and the at least one cross-member; and
a plurality of covers removably attached to the beam members for covering the plurality of RFID antenna components, said covers being generally curved in contour and being made of a material suitable for RF transmissions.

21. The RFID antenna rack of claim 20, wherein the beam members are substantially U-shaped.

22. The RFID antenna rack of claim 20, wherein the plurality of covers are generally elliptical in contour.

23. The RFID antenna rack of claim 20, wherein the plurality of covers are made of a dielectric material.

24. The RFID antenna rack of claim 20, wherein the one or more covers are ribbed across a lateral interior surface of each said cover for providing added strength to the covers and added structural integrity to the rack assembly.

25. The RFID antenna rack of claim 24, wherein the top further comprises a plurality of electrical connections for connecting plurality of RFID antenna components thereto.

26. The RFID antenna rack of claim 25, wherein the base, top, and beam members are made of metal and wherein said beam members are attached to the base and to the top via metal fasteners.

27. The rack assembly of claim 1, wherein the curvature of the covers are defined as one of a continuous curve and a multi-faceted geometric shape.

28. The rack assembly of claim 1, wherein the beam members define tab portions for providing added structural integrity to the rack assembly.
